(19) United States
(12) Patent Application Publication
(10) Pub. No.: US 2002/0174184 A1
(43) Pub. Date: Nov. 21, 2002

(54) Mailbox access mechanism over low-bandwidth, high-latency wireless networks

(75) Inventor: Louis Bouchard, Santa Cruz, CA (US)

Correspondence Address: HAVERSTOCK & OWENS LLP, 162 NORTH WOLFE ROAD, SUNNYVALE, CA, 94086, US

(73) Assignee: Avaya, Inc.

(21) Appl. No.: 09/842,747

(22) Filed: Apr. 25, 2001

(51) Int. Cl. G06F 15/16

(52) U.S. Cl. 709/206

(57) ABSTRACT

A push model notification and access mechanism to “push” the contents of a voice, fax, e-mail or unified mailbox to a wireless device such as a cellular phone where this information is locally cached and almost instantly displayed so that the user can interact with the mailbox content locally without the need to set up or maintain a network connection with a messaging server. The user may then send a command through the wireless device to the server to access particular items of the content list of the mailbox which is refreshed at every new message notification or after the mailbox has been accessed by the user using more traditional methods such as by telephone call.

### FIELD OF THE INVENTION

The present invention relates to messaging systems for wireless devices. More particularly, the present invention relates to an access mechanism for retrieving messages over low data-bandwidth, high data-latency wireless networks.

### BACKGROUND OF THE INVENTION

It is becoming increasingly desirable for an individual to gain remote access to her or his voice, fax or electronic mail messages. Additionally, with the increasing number of cellular phone users, the ability to access voice, fax or electronic mail messages by way of cellular phone is becoming more prevalent, creating the need for improving upon the traditional method of accessing messaging systems remotely.

To access their messages, cellular phone users would traditionally place a regular voice call into the messaging system, listen to automated voice prompts and enter dual-tone multi-frequency (DTMF) commands on their phone keypad. This process forces the user to go through each message serially, letting the system dictate the sequence in which the messages are presented. With this traditional approach, there is no efficient solution for letting users jump directly to a specific message in the mailbox.

Other approaches have been attempted, leveraging wireless phone visual displays and data transaction capabilities. For example, by using the Wireless Application Protocol (WAP), so-called “Internet” phones can display the content of the mailbox, let the user select a particular message and instruct the messaging system to play the chosen message.

This Internet phone mailbox access mechanism utilizes a classic client/server or command/response paradigm as illustrated in FIG. 1. Existing embodiments of this application, such as prototypes by Lucent Technologies and Converse Network Systems, utilize a WAP-enabled cellular phone as the “client” and the messaging system as the “server”.

In Step One 14 of such a prototype, the user must first initiate a connection from the Client 12 by issuing a command to authenticate the user and connect to the Server 10. After verifying and accepting credentials, the Server 10 then connects to the Client 12 as illustrated in FIG. 1 by Step Two 15. The time needed to complete Step One 14 and Step Two 15 can vary anywhere from a few to several seconds depending on a number of network conditions. For instance, several network elements such as routers, switches and gateways to the PSTN or the Internet may be involved in the connection, introducing long connect times and network latency. Furthermore, the relative low data bandwidth of currently deployed wireless networks restricts the amount of data that can be exchanged between the client and the server within a short time period.

In Step Three 16, the Client 12 issues a command to the Server 10 instructing the Server 10 to list the contents of the mailbox. In Step Four 17, the Server 10 returns the content list to the Client 12. This step again can typically take anywhere from two to ten seconds. In Step Five 18, the user can scroll through the list of messages and issue a command to listen to a particular message and in Step Six 19, the Server 10 plays the selected message.

All the delays associated with this access mechanism become generally unacceptable to even the most patient of users, making it much faster and convenient to retrieve messages using the conventional method of placing a call to a voice mail system. Because of long connect times, high latency and relative low bandwidth, it is not possible to implement a client/server approach that provides an adequate user experience similar to what one might expect on a standard web browser connected to the Internet.

### SUMMARY OF THE INVENTION

The present invention is a push model access mechanism which can provide visual access to a voice, a fax or an e-mail (unified) mailbox through a wireless network with low data bandwidth and high data latency.

The push model utilizes a wireless messaging bearer such as Short Message Service (SMS) to send the updated mailbox content list as a notification message. A data-capable wireless device such as a WAP phone receives the new message notification and stores the updated mailbox content list from the messaging server.

The wireless device is configured to allow the user to scroll through the updated mailbox content list. This step can be performed without accessing the wireless network. Lastly, the user issues a command to the server using the wireless device prompting the server to send a specific message back to the wireless device to be played or viewed by the user.

### BRIEF DESCRIPTION OF THE DRAWINGS

FIG. 1 illustrates a block diagram of the prior art.

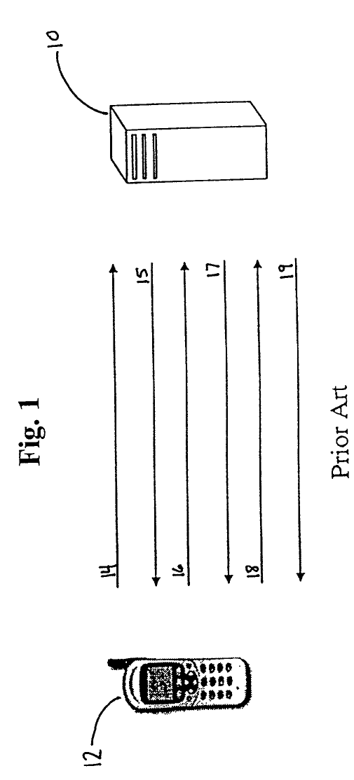

FIG. 2 illustrates a block diagram of the preferred embodiment of the present invention.

### DETAILED DESCRIPTION OF THE PREFERRED EMBODIMENT

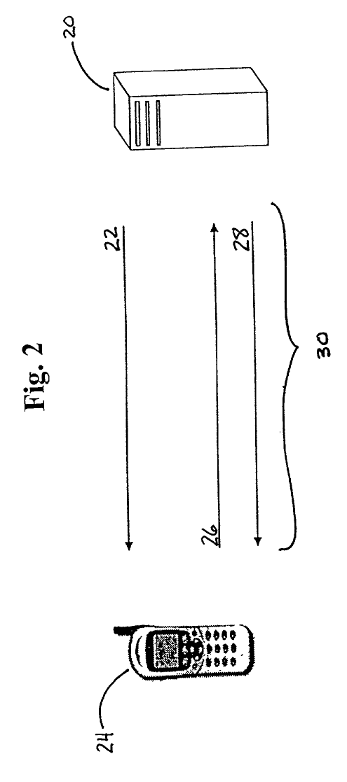

The preferred embodiment of the present invention is illustrated in FIG. 2. Like traditional access mechanisms, this embodiment utilizes both a Wireless Device 24 and a messaging Server 20 linked through a Wireless Network 30. However, in the preferred embodiment of the present invention, the Wireless Device 24 and the Server 20 interact more efficiently, thus providing the user with an optimal method of accessing voice, fax or e-mail messages.

According to the preferred embodiment of the present invention, the Wireless Device 24 is a WAP-enabled phone. Alternative embodiments of the present invention can utilize other devices such as, but not limited to, a personal digital assistant, a personal computer or a laptop. Various devices can be implemented in alternative embodiments and the Wireless Device 24 as described above is only illustrative of the preferred embodiment of the invention and is in no way a limitation.

Also in the preferred embodiment of the present invention, the Wireless Network 30 is a digital wireless voice network with Short Message Services (SMS) capabilities. Various wireless networks can be implemented in alternative embodiments and the Wireless Network 30 as described above is only illustrative of the preferred embodiment of the invention and is in no way a limitation.

The Server 20 of the preferred embodiment of the present invention can be a server of the type utilized in voice, fax, e-mail or unified mailbox systems operating according to the process. Various types of servers can be utilized in alternative embodiments and the Server 20 as described above is only illustrative of the preferred embodiment of the invention and is in no way a limitation.

In Step One 22 of the preferred embodiment, the Server 20 sends or “pushes” a new message notification and an updated mailbox content list to the Wireless Device 24 via SMS. The data comprising the new message notification and the updated mailbox content list is sent as data information. Accordingly in the preferred embodiment, the Wireless Device 24 includes data display technology. One example of such a Wireless Device 24 is a WAP-enabled cellular telephone. The new message notification and updated mailbox content list is preferably stored in the Wireless Device 24. The Wireless Device 24 can be configured to alert the user such as with a display notice, beep or tone, or a vibration. Thus, the user can view this list almost instantly. Further, because the data is stored in the Wireless Device 24, the user can interact with the mailbox content locally within the Wireless Device 24 without establishing a Wireless Network 30 connection to the Server 20. Commands such as “Call back sender”, “Call in mailbox to listen to message x”, “Delete message y” or “Save message z” can then be implemented using the most efficient Wireless Network 30 interaction possible such as a traditional telephony network call or a data network interaction.

After the user views the updated content list with the Wireless Device 24, Step Two 26 of the preferred embodiment of the present invention is a command by the user using the Wireless Device 24 to the Server 20 instructing the Server 20 to play a particular message. Playing the message may involve conversion of textual information into an audible form by using of a text-to-speech engine. Upon receiving the command from the Wireless Device 24, the Server 20 executes Step Three 28. In Step Three 28, the Server 20 sends the requested message to the Wireless Device 24 where the user may then either view a previously selected fax or e-mail message or listen to a previously selected voice message using just the Wireless Device 24.

Also in the preferred embodiment of the present invention, the content list is continually updated and sent by the Server 20 to the Wireless Device 24 every time a new message is received in the user's network mailbox. Additionally, the content list is updated after the user has accessed the mailbox by other traditional means, such as a telephone call.

The advantages of the preferred embodiment of the present invention compared to the traditional client/server paradigm are numerous. First, the preferred embodiment enables a much more responsive and faster interaction with the user because digital data is automatically transferred to a user's Wireless Device 24 without requiring the user to place a telephone call into or establish a data network session with the messaging server. This provides a much enhanced user experience. For instance, a traditional client/server approach could involve several minutes to retrieve new messages as compared to the almost instant retrieval time for the present invention. Also, the preferred embodiment reduces the complexity of implementation and support requirements for Internet/data connectivity to the messaging server and provides greater reliability and more scalability by reducing traffic and bandwidth requirements.

Additionally, the preferred embodiment of the present invention can be implemented using current technology and/or emerging standards and lowers the cost of developing the application while increasing its value to the end user. Lastly, by “pushing” the information rather than “pulling”, it will be easier to pass information through corporate firewalls and hence make the preferred embodiment viable to a much broader market base. For example, the push model can be a viable application option for customer premised-based messaging systems sitting behind a corporate Internet firewall.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention. Specifically, it will be apparent to one of ordinary skill in the art that the device of the present invention could be implemented in several different ways and the apparatus disclosed above is only illustrative of the preferred embodiment of the invention and is in no way a limitation.

We claim:

1. A method of utilizing a push model to provide access to a message list in one or more of a voice, a fax, an e-mail and a unified mailbox through a wireless network, the method comprising the steps of:
a. automatically receiving an updated mailbox content list from a server through a wireless network;
b. scrolling through the updated mailbox content list with a wireless device;
c. forming a communication link through the wireless network thereby linking the wireless device and the server;
d. selectively receiving a message from the server; and
e. providing the message to a user.

2. The method of claim 1 further comprising a new message notification, including the updated content list.

3. The method of claim 1 wherein the wireless network has a low data-bandwidth and a high data-latency.

4. The method of claim 1 further comprising the step of the user scrolling through the updated mailbox content list without accessing the wireless network.

5. The method of claim 1 further comprising the step of the user issuing the command using the wireless device.

6. The method of claim 1 further comprising the step of the server playing the message according to a command given by the user.

7. A system for providing access to a message list in one or more of a voice, a fax, an e-mail and a unified mailbox through a wireless network comprising:
a. a wireless device;
b. a server; and
c. a wireless network linking the wireless device with the server.

8. The system of claim 7 wherein the wireless network has a low data bandwidth and a high data latency.

9. The system of claim 7 wherein a new message notification and an updated mailbox content list are sent over the wireless network from the server to the wireless device.

10. The system of claim 7 wherein after being sent by the server, the new message notification and the updated content list can be viewed by a user with the wireless device.

11. The system of claim 7 wherein the user may scroll through the updated mailbox content list with the wireless device.

12. The system of claim 7 wherein the user selects a message by issuing a command to the server.

13. The system of claim 7 wherein the server delivers the message selected by the user and the message is played for the user by the wireless device.

14. A method of providing access to a message list in one or more of a voice, a fax, an e-mail or a unified mailbox through a wireless network, the method comprising the steps of:
a. automatically receiving through a wireless network a new message notification and an updated mailbox content list from a server;
b. remotely scrolling through the updated mailbox content list using a wireless device;
c. forming a communication link between the wireless device and the server; and
d. receiving and presenting a message from the server.

15. The method of claim 14 wherein the wireless network has a low data-bandwidth and a high data-latency.

16. The method of claim 14 further comprising the step of a user scrolling through the updated mailbox content list without accessing the data network.

17. The method of claim 14 further comprising the step of the user issuing the command using the wireless device.

18. The method of claim 14 further comprising the step of the server playing the message according to a command given by the user.

19. A system for providing access to a message list in one or more of a voice, a fax or a unified mailbox through a wireless network, the system comprising:
a. means for automatically receiving an updated mailbox content list from a server through a wireless network;
b. means for scrolling through the updated mailbox content list with a wireless device;
c. means for forming a communication link through the wireless network thereby linking the wireless device and the server;
d. means for selectively receiving a message from the server; and
d. means for providing the message to a user.

20. The system of claim 19 wherein a new message notification includes the updated mailbox content list.

21. The system of claim 19 wherein the wireless network has a low bandwidth and a high latency.

22. The system of claim 19 wherein the user scrolls through the updated mailbox content list without accessing the wireless network.

23. The system of claim 19 wherein the user issues a command using the wireless device.

24. The system of claim 19 wherein the server plays the message according to the command given by the user.
